(19) United States
(12) Patent Application Publication
(10) Pub. No.: US 2015/0027431 A1
(43) Pub. Date: Jan. 29, 2015

(54) Partially Transparent Lid For A Cooking Device

(71) Applicant: Derrick Miles, Raleigh, NC (US)

(72) Inventor: Derrick Miles, Raleigh, NC (US)

(73) Assignee: Modern Day Grilling Solutions, LLC, Raleigh, NC (US)

(21) Appl. No.: 13/950,246

(22) Filed: Jul. 24, 2013

(51) Int. Cl. A47J 36/06; A47J 37/07

(52) U.S. Cl. CPC A47J 36/06; A47J 37/0763
USPC 126/25 R; 99/341

(57) ABSTRACT

Embodiments of the present invention generally related to a cooking device, such as an outdoor barbecue grill, having a lid that is partially transparent. The lid having a two-part construction, the first part comprising a substantially transparent material, such as a tempered glass material, and the second part comprising a substantially non-transparent material, such as a steel composition. The lid can be used as a cover for covering the contents placed on a cooking surface of the cooking device, such that when the lid covers the cooking surface of the cooking device the contents on the cooking surface are still visible through the first part of the lid. As such, a person using the lid as a cover for a barbecue grill or the like can see the foods placed on the barbecue grill even when covered by the lid.

### BACKGROUND

Outdoor grills used for cooking have been in use for many years. Many of these outdoor grills generally consist of two main parts a bottom and a top. For those outdoor grills that are fueled by charcoal, the bottom portion of the outdoor cooking grills acts as a receptacle for storing the charcoal. Most, if not all, of these outdoor grills also have a grate for a cooking surface, where food is placed for grilling. In many instances, once food is placed on the cooking surface of the outdoor grill, it can only be observed directly when the top of the grill is not covering the cooking surface of the grill. The food items on the cooking surface are then only visible by the user of the outdoor grill when the top is displaced from the outdoor grill. As such, someone who is cooking food items on the grill but wishes to maintain certain cooking temperatures by allowing the outdoor grill to stay closed may have a tough time visually inspecting food items on the cooking surface of the outdoor grill. Therefore, there is a need to provide an apparatus that allows a user to visually inspect food items on a cooking surface of an outdoor grill while the top of the grill covers the cooking surface of the outdoor grill.

### BRIEF SUMMARY

The following presents a simplified summary of several embodiments of the invention in order to provide a basic understanding of such embodiments. This summary is not an extensive overview of all contemplated embodiments of the invention, and is intended to neither identify key or critical elements of all embodiments, nor delineate the scope of any or all embodiments. Its purpose is to present some concepts of one or more embodiments in a simplified form as a prelude to the more detailed description that is presented later.

### BRIEF DESCRIPTION OF THE DRAWINGS

Having thus described embodiments of the invention in general terms, reference will now be made to the accompanying drawings, wherein:

FIG. 1 illustrates an outdoor cooking device having a partially transparent cover, in accordance with some embodiments of the present application.

FIG. 2 illustrates an angled view of a cover for an outdoor cooking device, in accordance with some embodiments of the present invention.

FIG. 3 illustrates a top view of a cover for an outdoor cooking device, in accordance with some embodiments of the present invention.

FIG. 4 illustrates an outdoor cooking device having a partially transparent cover in an open position, in accordance with some embodiments of the present invention.

FIG. 5 illustrates an angled view of an outdoor cooking device having a partially transparent cover, in accordance with some embodiments of the present application.

### DETAILED DESCRIPTION

Embodiments of the present invention now will be described more fully hereinafter with reference to the accompanying drawings, in which some, but not all, embodiments of the invention are shown. Indeed, the invention may be embodied in many different forms and should not be construed as limited to the embodiments set forth herein; rather, these embodiments are provided so that this disclosure will satisfy applicable legal requirements. Like numbers refer to like elements throughout.

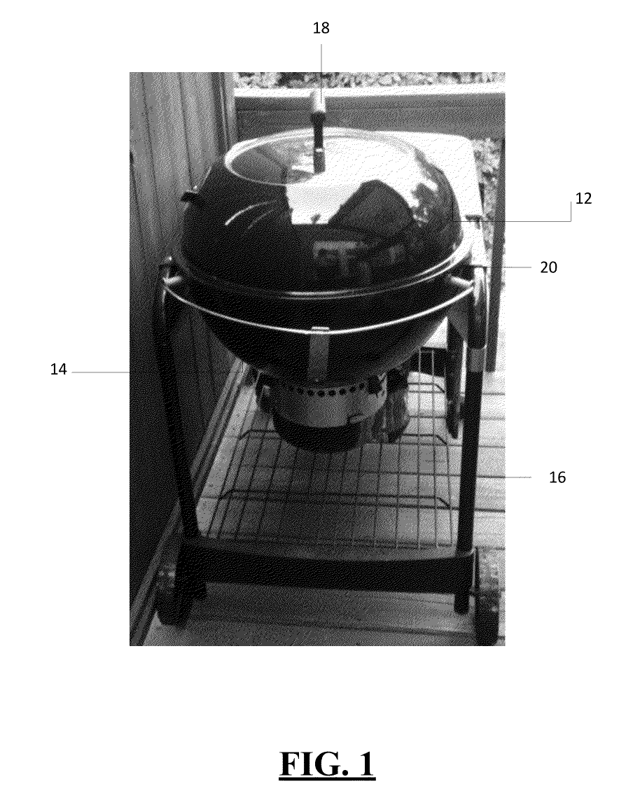

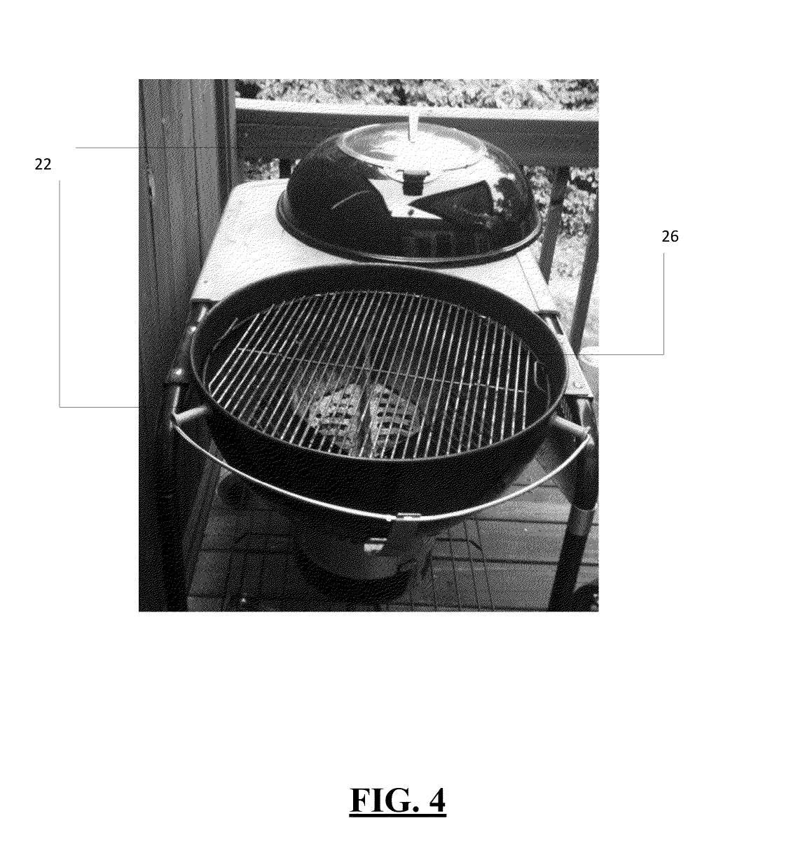

Referring now to FIG. 1, FIG. 1 represents a cooking device 10 having a partially transparent cover 12. In an exemplary embodiment, the cooking device 10 comprises a substantially hemispherical bottom 14 having a removable partially transparent cover 12. Cooking device 10, in some embodiments further comprise legs 16 for supporting cooking device 10 in a substantially upright position. Legs 16, in some embodiments are affixed to or secured to bottom 14 of cooking device 10. Opening and closing mechanism 18, such as a handle, is secured to the partially transparent cover 12, where the opening mechanism 18 is configured such that it can be used to remove the partially transparent cover 12 from bottom 14, when the cooking device 10 is in a closed position 20 or place the partially transparent cover 12 onto bottom 14, when the cooking device is in an opened position 22, as shown in FIG. 4. Also, a damper 24 is also secured to the partially transparent cover, wherein the damper 24 is configured such that it can be adjusted to control airflow through openings in the partially transparent cover 12. Additionally, the partially transparent cover has an opening and a hollow core. Bottom 14 of cooking device 10, in some embodiments, also comprises a surface 26, as shown in FIG. 4, that is configured for placing items thereon for cooking Bottom 14 of cooking device 10, in some embodiments, has a substantially hemispherical configuration that is configured to operatively communicate with partially transparent cover 12. Cooking surface 26, in some embodiments, is disposed within bottom 14 and substantially secured therein such that items can be placed thereon. Partially transparent cover 12 is configured, in some embodiments, such that it is substantially hemispherical or shaped as a dome. It will be understood that partially transparent cover 12 may be configured in any shape and is not limited to a substantially hemispherical configuration. For instance, cover 12 may be configured in a substantially polygonal shape or some other shape having a complex geometry that is non-polygonal.

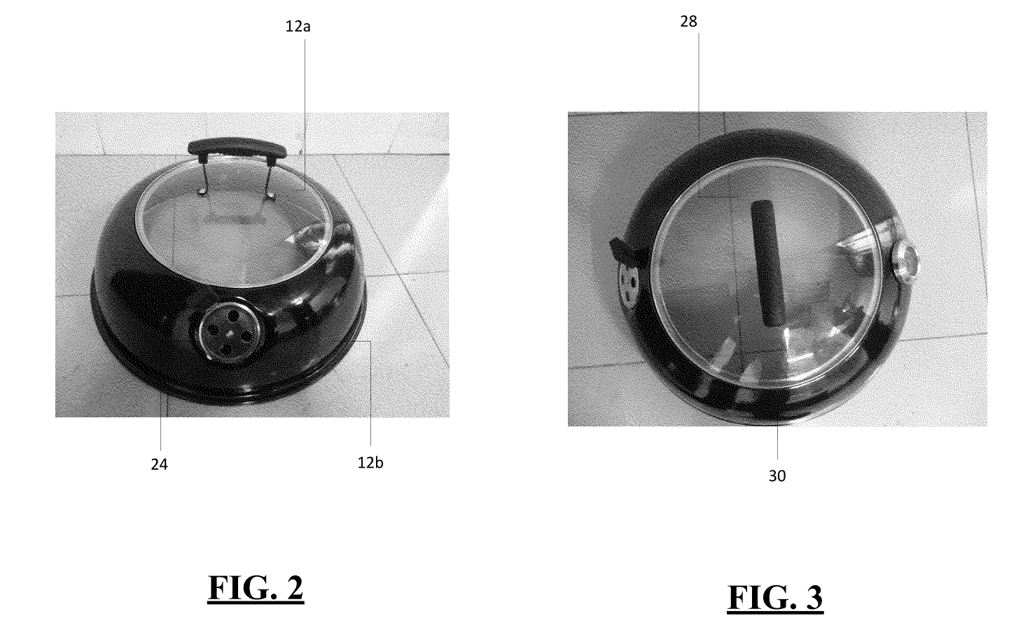

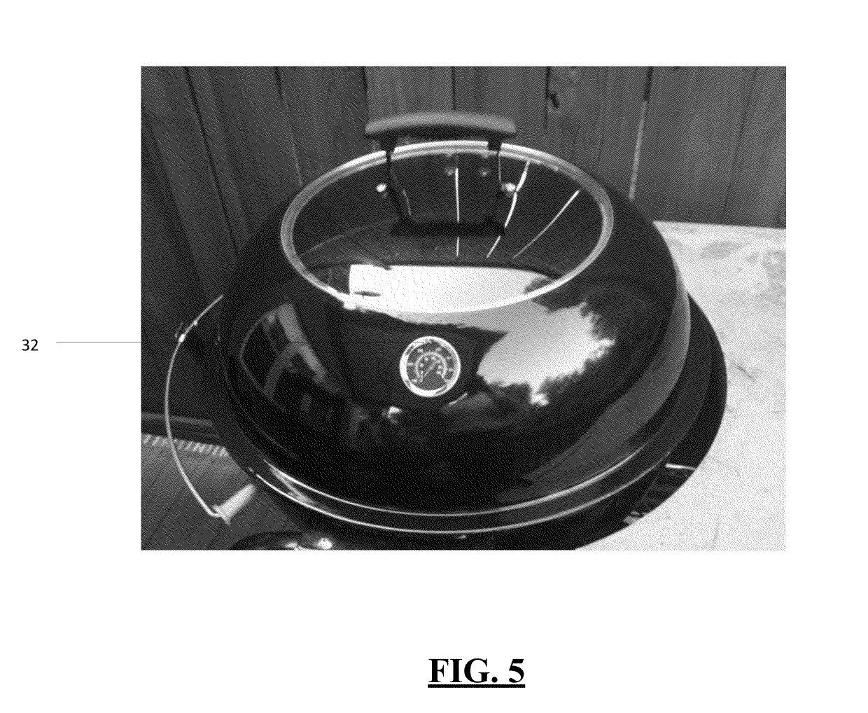

According to various embodiments, partially transparent cover 12, such as in FIG. 1, comprises a first part 12a and a second part 12b, as shown in FIG. 2, in accordance with some embodiments of the present invention. First part 12a of partially transparent cover 12, in some embodiments, comprises a transparent material, such that items on one side of first part 12a can be seen when looking through the opposite side of 12a. Thus, first part 12a comprises a material that permits light to transmit through either wholly or substantially. Second part 12b of partially transparent cover 12, in some embodiments, comprises a non-transparent material or substantially non-transparent material, such that items on one of second part 12b cannot be seen when looking through the opposite side of 12b. Thus, second part 12b comprises an opaque material that does not permit light to transmit through either wholly or substantially. In some embodiments, as shown in FIG. 5, a gauge 32, such as a temperature gauge, is in operative communication with the partially transparent cover 12 so that the gauge 32 can measure temperatures within, around, and/or associated with the partially transparent cover 12. In some embodiments, gauge 32 is affixed to a surface portion of partially transparent cover 12.

According to FIG. 2, in some embodiments, first part 12a is secured to second part 12b for forming partially transparent cover 12 and such that, if first part 12a is moved, 12b also moves inseparably and in tandem with 12a. In some embodiments, first part 12a comprises a substantially transparent glass material 28, as shown in FIG. 3, the substantially transparent glass material 28 is substantially heat resistant and in most embodiments, is configured to resist or not deform in the presence heat up to and exceeding 400 degrees Fahrenheit. In some embodiments, second part 12b comprises a metal material 30, as shown in FIG. 3. An example of the use of partially transparent cover 12 may be that when using cooking device 10 as an outdoor grill, food items may be placed on cooking surface 26, and when cooking device 10 is in a closed position with partially transparent cover 12, the food on cooking surface 26 can be seen by looking through first portion 12a of the partially transparent cover 12. An opening and closing mechanism 18 is affixed to first portion 12a, in some embodiments, and in other embodiments, opening and closing mechanism is affixed to second portion 12b of partially transparent cover 12.

In another embodiment, partially transparent cover comprises a top portion and a bottom portion. In some embodiments, top portion of partially transparent cover comprises a substantially non-transparent material. In some embodiments, bottom portion of partially transparent cover comprises a substantially transparent material. In other embodiments, top portion comprises a transparent material and bottom portion comprises a non-transparent material. An opening and closing mechanism 18 is affixed to top portion, in some embodiments, and in other embodiments, opening and closing mechanism is affixed to bottom portion of partially transparent cover.

In some embodiments, partially transparent cover comprises a first half and a second half. In some embodiments, first half of partially transparent cover comprises a substantially non-transparent material. In some embodiments, second half of partially transparent cover comprises a substantially transparent material. In other embodiments, first half comprises a transparent material and v comprises a non-transparent material. An opening and closing mechanism 18 is affixed to first half, in some embodiments, and in other embodiments, opening and closing mechanism is affixed to second half of partially transparent cover.

What is claimed:

1. A cover for an outdoor cooking device, the cover comprising:
a first portion comprising a substantially transparent material;
a second portion comprising a substantially non-transparent material, the second portion being secured to the first portion; and
a handle being affixed to the first portion or the second portion.

2. The cover of claim 1, wherein the first portion is tempered glass.

3. The cover of claim 2, wherein the second portion comprises a composition of metal.

4. The cover of claim 1, the cover having a substantially hemispherical configuration.

5. The cover of claim 2, wherein the second portion comprises an opaque material.

6. A lid for a cooking device, the lid comprising:
a top portion comprising a substantially transparent material;
a bottom portion comprising a substantially non-transparent material, the bottom being secured to the top portion, and the lid having a substantially hemispherical configuration; and
a mechanism being affixed to the top portion or the bottom portion, the mechanism being configured to move the lid from a first position to a second position with respect to a corresponding bottom of the cooking device.

7. An outdoor cooking device, the outdoor cooking device comprising:
a cover having a substantially hemispherical configuration, the cover having a first part that is transparent and a second part that is not transparent; and
a bottom having a substantially hemispherical configuration, the bottom being a receptacle, wherein an opening of the bottom is configured to communicate operatively with an opening of the cover.
